(19) United States
(12) Patent Application Publication
(10) Pub. No.: US 2003/0030934 A1
(43) Pub. Date: Feb. 13, 2003

(54) In-situ detection of transducer magnetic instability in a disc drive

(75) Inventors: Michael D. Schaff, Longmont, CO (US); Abhay T. Kataria, Longmont, CO (US)

Correspondence Address: MERCHANT & GOULD PC, P.O. BOX 2903, MINNEAPOLIS, MN, 55402-0903, US

(73) Assignee: Seagate Technology LLC

(21) Appl. No.: 10/057,274

(22) Filed: Jan. 24, 2002

Related U.S. Application Data
(60) Provisional application No. 60/311,136, filed on Aug. 9, 2001.

(51) Int. Cl. G11B 5/03; G11B 27/36; G11B 5/09

(52) U.S. Cl. 360/66; 360/25; 360/31; 360/53

(57) ABSTRACT

The method and apparatus herein identifies instability events occurring within a magneto-resistive head. The method commences by positioning magneto resistive head over a selected area of a disk that has no transitions, and then iteratively setting a read bias, and a thermal asperity threshold for counting and analysis of magneto resistive head instability events. The sensitivity of the thermal asperity detector is tuned to detect events that indicate magneto resistive head instability generated by the MR head over regions where magnetic transitions have been erased. The analyzed events are then used to determine the action taken related to the reliability of the head, that is, whether to reject or attempt to reduce the amount of instability related output. The apparatus includes without limitation a preamplifier, a read channel with a thermal asperity detector, and a comparator for counting and analyzing the resultant signals tested via biasing the magneto resistive head in a disc drive.

### RELATED APPLICATIONS

This application claims the benefit of the filing date of U.S. Provisional Patent Application Serial No. 60/311,136 filed Aug. 9, 2001 and entitled “METHOD FOR IN-SITU DETECTION AND MEASUREMENT OF RECORDING TRANSDUCER MAGNETIC INSTABILITY.”

### FIELD OF THE INVENTION

This application relates to disc drives and more particularly to an apparatus and method for detecting, during the course of disc drive manufacture, assembly, test, and use, a transducer possessing the undesirable characteristic of instability.

### BACKGROUND OF THE INVENTION

Recorded data is detected by a read/write head in a disc drive when the field of a recorded signal is brought in close proximity to the head. An inductive head detects a change in magnetic flux and generates a current. Detection circuitry responds to the induced current, identifying it as indicative of stored data. Alternatively, when a magneto-resistive head reads a magnetic field, it alters its own resistance. The detection circuitry detects the change in head resistance by continually running a current through the head, and identifying changes in voltage across the head. Regardless of how detection is to be accomplished, it is essential that the head's response to encountering a localized magnetic field of a recorded signal be predictable and repeatable. Variance in head response would frustrate the detection circuitry's ability to recognize data and result in errors generated during read operations.

Magneto-resistive heads (hereinafter, “MR head”) may possess a particular failure mechanism that is inconsistent with the goal of predictable response to magnetic field immersion. A magneto-resistive transducer is composed of layers of films in which resistance changes in the presence of a magnetic field. The films may contain a number of magnetic domains, which can change their orientation independently. Multiple magnetic domains acting independently within the films inside the transducer can result in an unpredictable, or nonlinear response in the MR head.

This failure mechanism may be the result of manufacturing or assembly errors, or undesirable environmental events that occur during the lifetime of the MR head. For example, manufacturing errors that result from manufacturing defects include voids, contamination, or material defects in a given region within the MR head. Similarly, physical impacts, electrical discharges, temperature effects encountered by the magneto-resistive head, or various mishandling that occurs during the assembly process result in errors. Environmental events often include without limitation, degradation of materials and undesirable exposure to various levels of moisture, temperature, or debris.

Failure mechanisms, or magnetic instability within the magnetic recording heads can be detected when the MR head reads a magnetic field transition. The MR head generates an output signal upon exposures to magnetic fields by changing its resistance. Repetitive and consistent reaction to the change of field is compromised when magnetic domains within the MR head reorient their magnetic moment, resulting in a change in readback signal.

Head instability is likely to generate an increase in error rates in the disc drive. Since head stability can be a function of time or environmental variables, error rates due to an unstable head may get worse with age or changing environments. Therefore, the data within the read/write storage device may become unrecoverable. Moreover, if other conditions which contribute to error rates such as off track, or poor signal to noise ratios are present, head instability may become even more difficult to distinguish with present detection methods.

It is the function of the transducer in the MR head to produce a signal of changing voltage or current as it travels over a recorded magnetic transition on the rotating disc. Where there are no recorded transitions, or when the disc is not spinning, there should be no readback signal generated by the readback transducer. Transducers with instabilities will frequently produce output signals independently, even without the presence of recorded transitions on a rotating disc. These signals can be of varying frequency and amplitude. They are typically the result of magnetic domain switching or reorientation of magnetic moments within the transducer or magneto-resistive head.

The characteristics of detected instability signals may be indicative of an operable MR head, but may also be indicative of potential failing or progressively unreliable MR heads. Temperature in the disc drive environment may also accelerate failure of the MR head. Moreover, functional problems associated with defective MR heads, such as read/write errors or data recovery errors, may be later borne by the consumer.

Present testing techniques and analysis of magnetic characteristics of an MR head are difficult to perform in-situ, i.e. once the transducer has been assembled and affixed to an actuator arm within the disc drive. Typical MR head instability detection techniques consist of tracking and analyzing poor error rates within data transfer of the recording heads. However, detection of poor error rates are translated without distinction of diverse, numerous problems. For example, poor error rates may be indicative of a head flying too high above a rotating disc, creating a low signal to noise ratio. Poor error rates can also be indicative of track misregistration, track encroachment, media defects or thermal decay. Known present art techniques do not separate and distinguish magnetic instability in MR heads from other error rate failure mechanisms.

Against this backdrop embodiments of the present invention have been developed.

### SUMMARY OF THE INVENTION

The method and apparatus in accordance with embodiments of the present invention solves the aforementioned problem and other problems by isolating MR head instabilities associated with assembly/manufacturing errors and environmental events. The present invention uses available (in-situ) components to isolate MR instability failure mechanisms. One embodiment of the invention uses a detection method wherein the sensitivity of a thermal asperity (TA) detector is tuned to isolate and analyze noise or stability related events produced by the MR head. The functions of TA detector typically include detection of large amplitude events related to temperature changes in the MR head created by interference with debris or the disk surface. However, this embodiment method, by using increased thermal asperity sensitivity, is useful in characterizing the quality and predicted reliability of the MR head's function. Information provided through analysis of the thermal asperity detection system can be used in repair or maintenance of the MR head. Similarly, such MR head failure data may be used to reject the MR head's use and initiate data recovery schemes.

The method and apparatus detects signals produced by the MR head, (typically in current or voltage), which may translate to magnetic domain activity, then adjusts control signals within the reading or writing head to compensate for MR head instability. MR head instability events are counted and analyzed in the method of the present invention. The in-situ method commences by selecting an MR head, which is being tested, then an initial TA detection threshold is set. A read bias based on MR head specific values is also set. The writer (inductive write element on the head) is energized and magnetic transitions are erased over a pre-determined track on the disc. Next, empirical data from signals that emanate from the MR head are collected and analyzed, typically through the use of a comparator unit. Erasure pointers, or flags, where the signals emanating from the biased MR head exceed the TA detection threshold, are detected and counted. The steps of biasing the MR head, energizing the writer and erasing magnetic transitions while detecting and counting erasure pointers are repeated within a subroutine of the method. The read bias is generally incremented or decremented during the method for a range of different biases. The range of biases is typically determined by the resistive properties specific to each individually selected MR head. Further steps of the present invention include without limitation, incrementing or decrementing the writer current, and TA detection threshold between each step of adjusting the read bias, while erasure pointers are detected and counted.

The apparatus includes a read channel component or a pre-amplifier, containing a TA detector, which is used to adjust TA sensitivity or thresholds to assist in detecting and analyzing failure mechanisms associated with the target MR head. During the application of a read bias to the MR head, an erased track on the disc is used to distinguish signals indicative of failure mechanisms in the MR head. The read bias is incrementally adjusted during detection of the signals. Within the apparatus a comparator unit coupled to the TA detector is used to compare the signal from a biased MR head to the threshold set in the TA detector to further analyze and detect erasure pointers during a test routine. Additionally, the TA detector can also be adjusted while iteratively varying the read bias.

This method and apparatus allows the monitoring and characterization of a MR head for purposes of adjusting both the read/write head, while placing criteria on it for possible rejection. Moreover, the method allows detection of error prone MR heads from the various stages of manufacturing and assembly throughout the lifetime use of the MR head within a disc drive. Furthermore, the method provides the ability for detection and possible correction of the MR head during these stages. Quantities of erasure pointers that exceed thresholds are further analyzed for adjusting the MR head to correct or prevent errors from occurring, while extending the life of the disc drive.

These and various other features as well as advantages of the present invention will be apparent from a reading of the following detailed description and a review of the associated drawings.

### BRIEF DESCRIPTION OF THE DRAWINGS

FIG. 1 is a plan view of a disc drive incorporating an embodiment of the present invention.

FIG. 2 provides a functional block diagram of the servo control system of the drive in FIG. 1, a representation of a portion of a selected track of the disc drive of FIG. 1.

FIG. 3 is a flow diagram of a method of in-situ transducer magnetic instability detection in accordance with an embodiment of the invention.

FIG. 4 is flow diagram of one another embodiment of a method of in-situ transducer magnetic instability detection in accordance with the present invention.

FIG. 5 is a functional diagram as in FIG. 2 having a more detailed diagram of the read portion of the read/write channel of an embodiment of the apparatus.

FIG. 6 is a set of signal waveforms depicting signal detection capabilities of the present invention.

### DETAILED DESCRIPTION

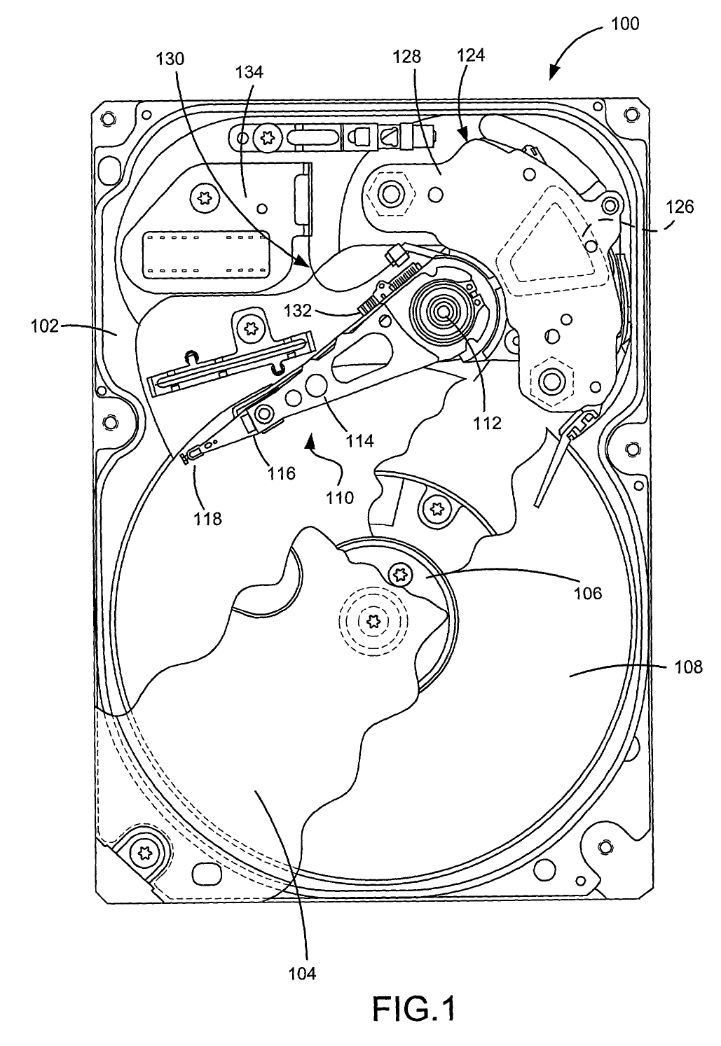

A disc drive 100 constructed in accordance with a preferred disc drive embodiment of the present invention is shown in FIG. 1. The disc drive 100 includes a base 102 to which various components of the disc drive 100 are mounted. A top cover 104, shown partially cut away, cooperates with the base 102 to form an internal, sealed environment for the disc drive in a conventional manner. The components include a spindle motor 106 which rotates one or more discs 108 at a constant high speed. Information is written to and read from tracks (not shown) on the discs 108 through the use of an actuator assembly 110, which rotates during a seek operation about a bearing shaft assembly 112 positioned adjacent the discs 108. The actuator assembly 110 includes a plurality of actuator arms 114 which extend towards the discs 108, with one or more flexures 116 extending from each of the actuator arms 114. Mounted at the distal end of each of the flexures 116 is a transducer head 118 which includes an air bearing slider enabling the head 118 to fly in close proximity above the corresponding surface of the associated disc 108.

During a seek operation, the track position of the heads 118 is controlled through the use of a voice coil motor (VCM) 124, which typically includes a coil 126 attached to the actuator assembly 110, as well as one or more permanent magnets 128 which establish a magnetic field in which the coil 126 is immersed. The controlled application of current to the coil 126 causes magnetic interaction between the permanent magnets 128 and the coil 126 so that the coil 126 moves in accordance with the well known Lorentz relationship. As the coil 126 moves, the actuator assembly 110 pivots about the bearing shaft assembly 112, and the heads 118 are caused to move across the surfaces of the discs 108.

The spindle motor 106 is typically de-energized when the disc drive 100 is not in use for extended periods of time. The heads 118 are typically moved over park zones 120 near the inner diameter of the discs 108 when the drive motor is de-energized. The heads 118 are secured over the park zones 120 through the use of an actuator latch arrangement, which prevents inadvertent rotation of the actuator assembly 110 when the heads are parked.

A flex assembly 130 provides the requisite electrical connection paths for the actuator assembly 110 while allowing pivotal movement of the actuator assembly 110 during operation. The flex assembly includes a preamplifier printed circuit board 132 to which head wires (not shown) are connected; the head wires being routed along the actuator arms 114 and the flexures 116 to the heads 118. The printed circuit board 132 typically includes circuitry for controlling the write currents applied to the heads 118 during a write operation and a preamplifier for amplifying read signals generated by the heads 118 during a read operation. The flex assembly terminates at a flex bracket 134 for communication through the base deck 102 to a disc drive printed circuit board (not shown) mounted to the bottom side of the disc drive 100.

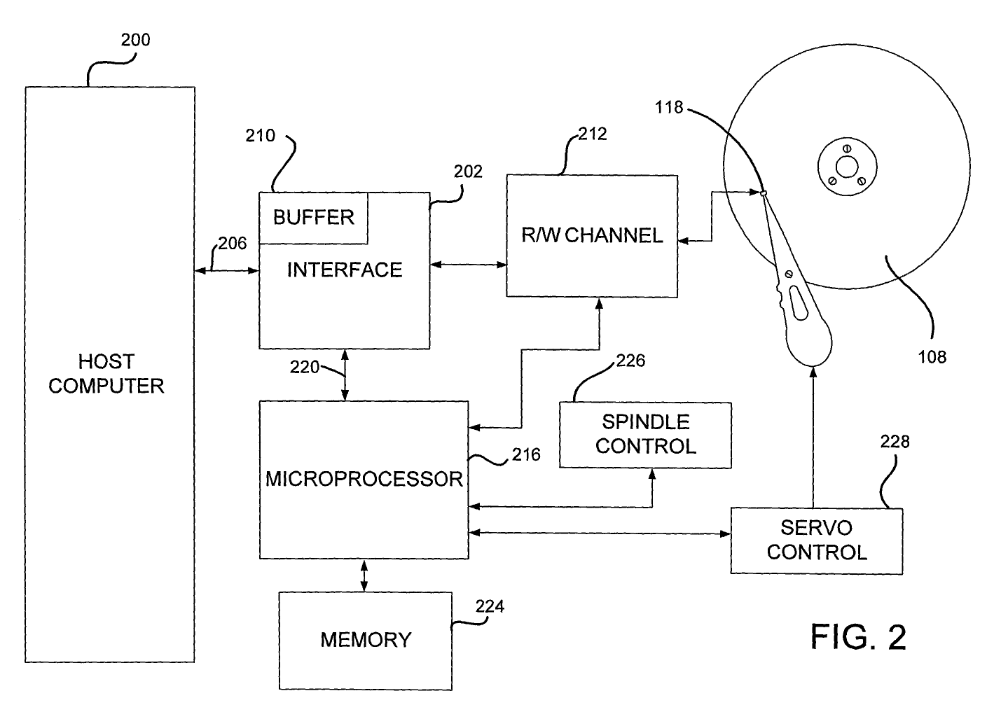

Referring now to FIG. 2, shown therein is a functional block diagram of the disc drive 100 of FIG. 1, generally showing the main functional circuits which are resident on the disc drive printed circuit board and used to control the operation of the disc drive 100. The disc drive 100 is operably connected to a host computer 200 in a conventional manner. Control communication paths are provided between the host computer 200 and a disc drive microprocessor 216, the microprocessor 216 generally providing top level communication and control for the disc drive 100 in conjunction with programming for the microprocessor 216 stored in microprocessor memory (MEM) 224. The MEM 224 can include random access memory (RAM), read only memory (ROM) and other sources of resident memory for the microprocessor 216.

The discs 108 are rotated at a constant high speed by a spindle motor control circuit 226, which typically electrically commutates the spindle motor 106 (FIG. 1) through the use of back electromotive force (BEMF) sensing. During a seek operation, wherein the actuator 110 moves the heads 118 between tracks, the position of the heads 118 is controlled through the application of current to the coil 126 of the voice coil motor 124. A servo control circuit 228 provides such control. During a seek operation the microprocessor 216 receives information regarding the velocity of the head 118, and uses that information in conjunction with a velocity profile stored in memory 224 to communicate with the servo control circuit 228, which will apply a controlled amount of current to the voice coil motor coil 126, thereby causing the actuator assembly 110 to be pivoted.

Data is transferred between the host computer 200 or other device and the disc drive 100 by way of an interface 202, which typically includes a buffer 210 to facilitate high-speed data transfer between the host computer 200 or other device and the disc drive 100. Data to be written to the disc drive 100 is thus passed from the host computer 200 to the interface 202 and then to a read/write channel 212, which encodes and serializes the data and provides the requisite write current signals to the heads 118. To retrieve data that has been previously stored in the disc drive 100, read signals are generated by the heads 118 and provided to the read/write channel 212, which performs decoding and error detection and correction operations and outputs the retrieved data to the interface 202 for subsequent transfer to the host computer 200 or other device. Such operations of the disc drive 100 are well known in the art and are discussed, for example, in U.S. Pat. No. 5,276,662 issued Jan. 4, 1994 to Shaver et al.

The transducer head 118 carries a magneto-resistive (MR) head read element and an inductive write element (writer) in the trailing edge of an air-bearing slider. The MR element will be referred to subsequently in this description as an MR head. The heads 118 in the disc drive 100 are positioned over an area of the rotating disc 108 where magnetic transitions have been erased in embodiments of the present invention. A thermal asperity (TA) detector circuit in the read channel 212 is used to detect and quantify the amount of output coming from the read transducer. Any output signal generated by the read transducer positioned over an area with no written transitions will be amplified, filtered, and compared to a known voltage within a comparator using the TA detector. The comparator threshold can be adjusted to make it possible to detect low or high amplitude signals coming from the read transducer. The drive electronics will detect and quantify the number of signal events that exceed the comparator threshold as erasure pointers on each MR head within a disc drive.

Levels of head instability can also vary with the amount of bias current or voltage applied to the read transducer. Also, energizing the writing element of the recording head can produce changes in the level of stability within the head. The present invention energizes the write element of the head 118 and also applies a range of bias current or voltage to the read element during thermal asperity detection routines, in an attempt to expose these instabilities. The transducer magnetic instability detection method is used over a range of voltage/current bias settings, repeated over a number of write cycles, and further repeated while adjusting the TA threshold over a pre-determined range. Heads 118, which show output or erasure pointers in the system, have been confirmed to be unstable, and are known to produce error rate related failures.

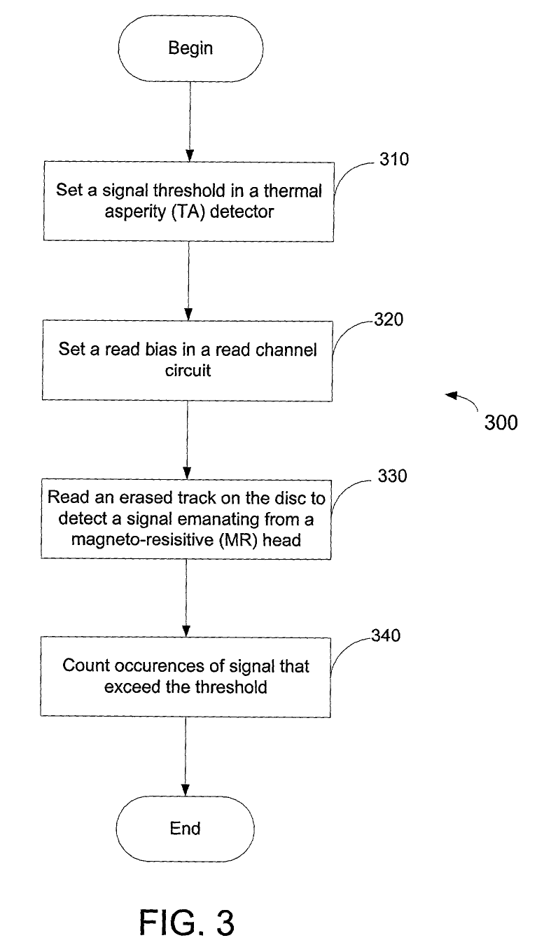

FIG. 3 illustrates a simplified flow diagram of the operational environment of a transducer magnetic instability detection system 300 according to an illustrative embodiment. In this embodiment, and other embodiments described herein, the logical operations of the transducer magnetic instability detection system 300 may be implemented as a sequence of computer implemented steps or program modules running on a microprocessor, such as, a read channel within a disc drive coupled to a microprocessor, or a pre-amplifier operably connected to the MR head and microprocessor. It will be understood to those skilled in the art that the transducer magnetic instability detection system 300 may also be implemented as interconnected machine logic circuits or circuit modules within a computing system. Additionally, the transducer magnetic instability detection system may be implemented in a separate component of the disc drive, such as a dedicated servo controller. The implementation is a matter of choice dependent on the performance and design requirements of the disc drive. As such, it will be understood that the operations, structural devices, acts, and/or modules described herein may be implemented in software, in firmware, in special purpose digital logic, and/or any combination thereof without deviating from the spirit and scope of the present invention as recited within the claims attached hereto. Furthermore, the various software routines or software modules described herein may be implemented by any means as is known in the art. For example, any number of computer programming languages, such as “C”, “C++”, Pascal, FORTRAN, assembly language, Java, etc., may be used. Furthermore, various programming approaches such as procedural, object oriented or artificial intelligence techniques may be employed.

Referring to FIG. 3, in one embodiment of the invention, steps of the transducer magnetic instability detection system 300 may be stored in some form of computer readable media. As used herein, the term computer-readable media may be any available media that can be accessed by a processor or component that is executing the functions or steps of the transducer magnetic instability detection system 300. By way of example, and not limitation, computer-readable media might comprise computer storage media and/or communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EPROM, flash memory or other memory technology, CD-ROM, digital versatile discs (DVD) or other optical storage, magnetic cassettes, magnetic tape, magnetic disc storage or other magnetic storage devices, or any other medium that can be used to store the desired information and that can be accessed by the computer or processor which is executing the operating code.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

Within the present invention flow diagram in FIG. 3 represents a simplified embodiment of the transducer magnetic instability detection system. Within the instability detection system 300, the process begins with threshold setting 310, which includes the step of setting a threshold in a thermal asperity (TA) detector. Thresholds within the TA detector typically consist of pre-determined settings, but can be variable values within the present invention. By way of example, TA detector thresholds may consist of several settings equally divided among a pre-determined range of voltages, such as in one embodiment, where eight settings are spread over a range of 36 millivolts (mV) to 291 mV. Bias setting 320 includes the step of setting a bias over a predetermined range of values, where the range of values are usually dependent of a magnetic characteristic of the MR head, such as resistance. Such MR head metrics are used to determine a voltage target, or a predicted tolerance value specific to the MR head for determining the reliability and performance of the MR head. Reading an erased track 330 includes the steps of positioning the MR head over a pre-determined track to detect a signal emanating from the MR head. Counting occurrences 340 includes the steps of counting the number of signals that exceed the threshold, or events that occur when comparing the signal to the threshold.

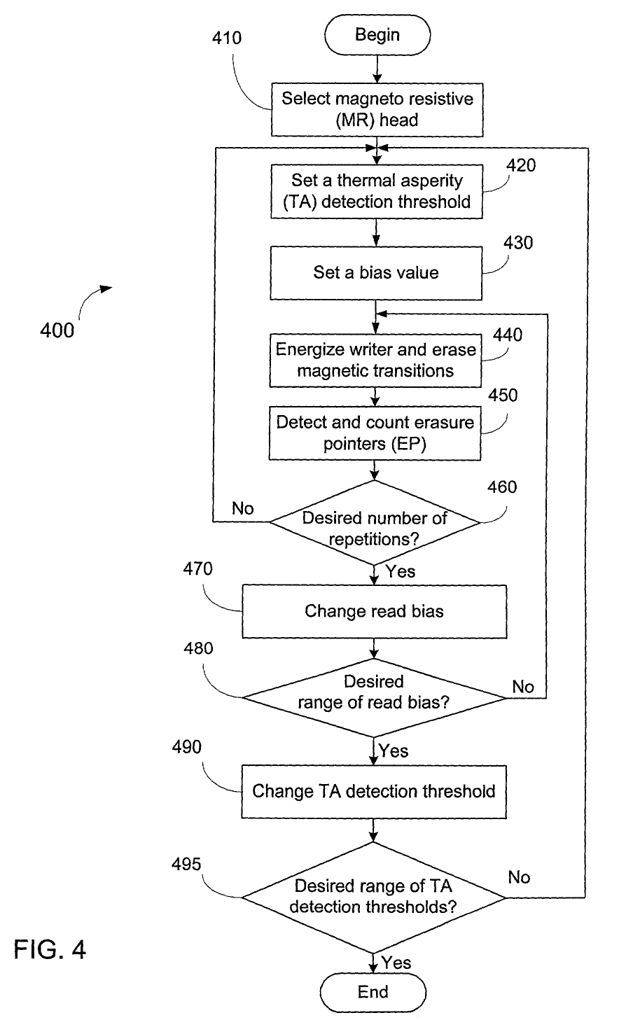

Instability detection and measurement process 400 in FIG. 4 represents another embodiment of the present invention. Within selection step 410 an MR head is selected for instability detection and measurement. Within a disc drive one or many MR heads are affixed to an actuator arm for reading/writing to one or many discs within the drive. However, one MR head is selected during process 400, and the remaining heads are selected later for detection and measurement. Threshold setting step 420 includes the setting of a threshold in a TA detector. As previously discussed, TA thresholds may be selected from fixed, pre-determined thresholds or they may be adjustable thresholds. A read bias is set in step 430 to a value typically based on a magnetic characteristic specific to the selected MR head. However, the bias value can be adjusted to ranges independent of the magnetic characteristic of the MR head. Erasing step 440 includes energizing the writer of the MR head after positioning the head over a desired track to erase magnetic transitions on the track. Alternately, the MR head can be positioned over a known erased track to accomplish similar features of step 440. Once an erased track has been identified or made available, signals are detected and counted in step 450. Detecting and counting 450 includes without limitation reading a signal emanating from the MR head that exceed the threshold set in step 420. Signals giving an indication where input exceeds threshold are flagged as erasure pointers. Erasure pointers may be also flagged through designated pins on a chip, detected by the present invention. These erasure pointers or events are counted within step 450. Repetition decision step 460 repeats steps 420 through step 450 for a pre-determined number of repetitions until a condition is met. Generally, the number of repetitions selected is low, but sufficient to eliminate anomalies or to produce a statistically acceptable reading of signals or erasure pointers. For example, in one embodiment, the number of repetitions is set at five, and upon five iterations of step 460 the condition is satisfied and the process continues to step 470. Upon satisfaction of the repetition decision, the read bias is changed to a new value in step 470. Change bias step 470 includes incrementing or decrementing the read bias to a new value. The range of bias decision step 480, includes without limitation repeating steps 440 through step 470 until the range of biases have been cycled through steps 440 through step 470. Upon the completion of iteratively stepping through the range of biases, step 490 changes the threshold of the TA detector. Change threshold step 490 includes without limitation incrementing or decrementing the TA detector threshold. The range of TA threshold decision step 495, includes repeating steps 420 through step 490 until desirable thresholds have been stepped through within the range of thresholds.

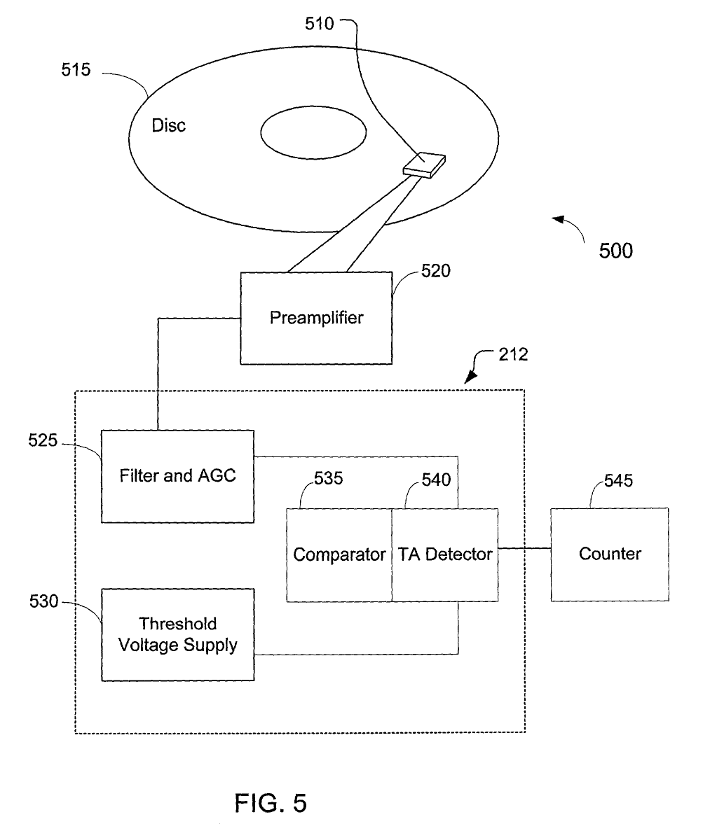

In FIG. 5, apparatus 500 represents one embodiment of the present invention. Within an operating disc drive, one or more transducers 118 having MR heads 510 are attached to actuator arms positioned above the surfaces of one or more discs 108. In operation, MR head 510 is arcuately positioned over spinning disc 108 to read/write data recorded on tracks within disc 108. Read channel 212 is connected to the MR head 510 via read/write pre-amplifier 520. Preamplifier 520 conditions signals from the read element of the head 510 for use within the read channel 212, where read channel 212 encodes/decodes signal data for transfer via interface 202 and eventual use by host computer 200. Components within the read channel 212 includes a filter and automatic gain control (AGC) unit 525, a threshold voltage supply 530, a comparator 535, and a thermal asperity (TA) detector 540. The filter and AGC unit 525 filters noise emanating from the MR head 510. Threshold voltage supply 530 provides threshold value for signal comparison conducted within the comparator 535, which is coupled to TA detector 540. The comparator 535 compares signals to the threshold set within TA detector 540, while counter 545 counts the number of occurrences in which a signal exceeds the threshold.

In one embodiment of the present invention, the TA detector 540 (shown in FIG. 5) is a component within the read channel 212. In an alternate embodiment the TA detector 540 may be a component connected to or subcomponent part of preamplifier 520. In one embodiment of the present invention, TA detector 540 is a component within read channel 212; however, in alternate embodiments the TA detector 540 may be a component connected to or part of preamplifier 520. For alternate embodiments of the present invention, read/write preamplifiers also have thermal asperity detection capabilities, which could be used in place of, or in addition to the read channel thermal asperity detector. The present invention could also be made to work with different numbers of write cycles, write currents, read bias current/voltage ranges, and will work on different locations of the rotating disc.

In any of the embodiments of the present invention, the invention can be used in the disc drive test process, and can also be made active in the end user environment to provide notification that head instability conditions exist within the disc drive. Such detections at various stages of disc drive life cycles promote opportunity and adjustment of the MR head parameters such as current or voltage bias to realign or reorient magnetic domains within the MR head. These corrections improve transducer reliability and reduce error rates within the disc drive while extending the lifetime of the magneto-resistive head and the disc drive itself.

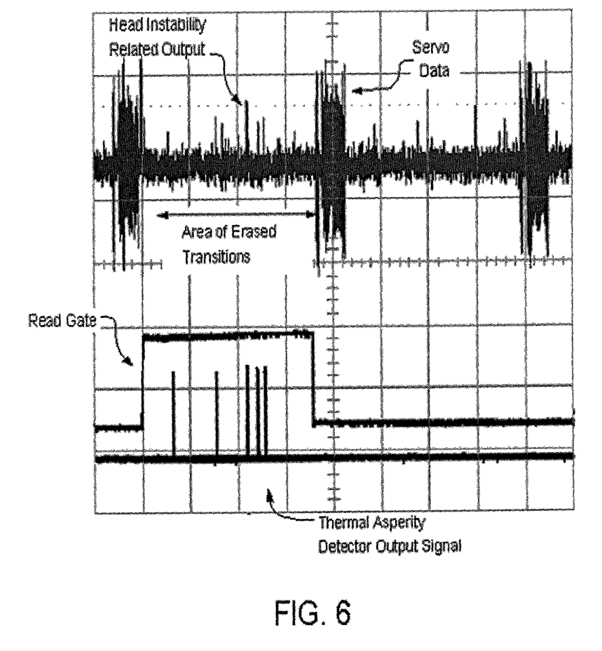

FIG. 6 represents various signal outputs from the transducer using an oscilloscope within the present invention. By way of example, a selected track having erased magnetic transitions is sampled and analyzed after increasing the sensitivity of a TA detector. A TA comparator threshold voltage is chosen, and a read gate is established for detecting signals generated by the MR head while the read element is positioned over the area of the disk where magnetic transitions have been erased. Signals generated by the MR head due to magnetic instabilities are sensed while read gate is active. Where the signals produced by the head due to magnetic instabilities are of amplitude that exceeds the threshold set at the comparator, output pulses will be generated by the TA detector. The output pulses from the TA detector will be issued as erasure pointers that are to be counted. The number of erasure pointers that exceed the threshold are counted and analyzed for determining the reliability or predicted performance of the MR head. MR heads are then evaluated for possible maintenance schemes or rejection. The present invention provides an opportunity for this assessment while also providing the opportunity to recover data as needed prior to action taken related to the MR head.

In summary, the present invention may be viewed as a method (such as 300) of detecting and measuring instability within the MR head (such as 510) within a disc drive (such as 100), in which the disc drive has a plurality of tracks and a magneto resistive (MR) head (such as 510) positioned above the tracks. The method includes setting a threshold in a thermal asperity detector (such as 310) connected to the MR head (such as 510) and applying a read bias to the MR head (such as 320). The method also includes reading a signal emanating from the MR head positioned over an erased track (such as 330), counting a number of occurrences of signals that exceed the threshold (such as 340) to determine transducer magnetic instability within the MR head based on the number of occurrences of signals that exceed the threshold. The further includes adjusting the read bias to a new value within a range of values (such as 470), while repeating the steps of reading, counting, and determining transducer instability (such as 450). The range of values is based on a characteristic of the MR head resistance. The method also includes re-setting the thermal asperity detector to a new threshold (such as 490) and repeating the steps of reading, counting, and determining transducer magnetic instability. The method further includes realigning the magnetic domains of the MR head if the number of signal occurrences exceeds a pre-determined number. Applying a pre-determined write or read current/voltage to the MR head may be used to perform the realignment.

A computer readable medium having computer-executable instructions may be used for performing the steps within the above method. The method for detecting transducer magnetic instability in a MR head for an operating disc drive includes without limitation, setting a signal threshold in a thermal asperity detector in a disc drive read channel circuit (such as 420), setting a read bias in a read channel circuit (such as 430), reading an erased track on the drive to detect a signal emanating from the MR head (such as 440), and counting an occurrence of the signal if the signal exceeds the signal threshold (such as 450). The method further includes re-setting the read bias to a new bias (such as 470), while repeating the reading and counting steps of the method (such as 450). The method also includes performing the re-setting of the read bias (such as 470) and repeating the reading and counting steps (such as 450) for a pre-determined number of repetitions. Additionally, the method may include the re-setting (such as 470) and repeating the reading and counting steps (such as 450) of the method are repeated until there are no occurrences of signals that exceed the threshold. The method may also include performing such repetitions for five (5) cycles. In addition to the aforementioned steps of the method, the method may include re-setting the signal threshold to a new signal threshold (such as 490) and repeating the setting of a read bias (such as 470), the reading on a erased track (such as 450), and counting of the number signal occurrences exceeding the threshold (such as 450). The method also includes repeating the re-setting of the signal threshold (such as 490) and repeating the setting of a read bias (such as 470), the reading of an erased track (such as 450), and the counting of signal occurrences for a pre-determined number of repetitions.

The method includes setting a first criterion based on a characteristic of the MR head, and comparing the counted number of occurrences of the signals that exceed the threshold to the first criterion to determine a reliability value to the MR head. The method also includes rejecting the MR head if the reliability value is outside a second criterion. The method may also include re-aligning magnetic domains within the MR head based on the reliability value by applying a pre-determined write or read current/voltage to the MR head. The current/voltage may be based on the reliability value. The method includes attenuating the signal emanating from the MR head to a level within a range of pre-determined signal thresholds, or amplifying the signal emanating from the MR head to a level within a range of pre-determined signal thresholds. These steps within the method may be performed by a computer readable medium having computer-executable instructions.

The present invention may also viewed as an apparatus (such as 500) for detecting and measuring instability in a MR head (such as 510) in an operating disc drive (such as 100). The MR head (such as 510) has a magnetic orientation and is positioned over a predetermined track on a disc in the drive. The apparatus (such as 500) includes without limitation, a thermal asperity detector (such as 540) in the disc drive (such as 100) connected to the MR head (such as 510). The thermal asperity detector (such as 540) capable of having an adjustable threshold set to a pre-determined value. The apparatus (such as 500) also includes a read bias applied to the MR head (such as 510). The bias is selected from a range of values, in which the values are based on the MR head resistance to a magnetic field. The apparatus (such as 500) includes a signal generated by the MR head while the MR head is positioned over an erased track. The apparatus includes a software module connected to the thermal asperity detector (such as 540) for comparing the signal from emanating from the MR head to the pre-determined threshold. The software module also counts occurrences in which the signal exceeds the pre-determined threshold. The software within the apparatus may also include a comparator (such as 535) connected to the read channel (such as 212) for comparing the signal from the MR head (such as 510) to the pre-determined threshold, which also includes a counting unit (such as 545) counting occurrences in which the signal exceeds the pre-determined threshold. The apparatus may also include a thermal asperity detector (such as 540) connected to the MR head via a read channel (such as 212) and a software module connected to the thermal asperity detector (such as 540) via the read channel (such as 212). In addition, the TA detector (such as 540) of the apparatus may be connected to the MR head via a pre-amplifier (such as 520) with the software module connected to the TA detector (such as 540) via the pre-amplifier (such as 520). The apparatus includes a means for adjusting the write or read bias to re-orient the magnetic domains within the MR head based on the number of occurrences of signals exceeding the threshold. The apparatus also includes a means for adjusting the signal emanating from the magneto-resistive head. The means for adjustment may include attenuating or amplifying the signal to a level within the range of settings for the threshold.

What is claimed is:

1. In a disc drive having a plurality of tracks and a magneto resistive (MR) head positioned above the tracks to access magnetic information stored on the tracks and a thermal asperity detector circuit operably connected to the MR head, a method of detecting and measuring instability within the MR head comprising steps of:
setting a threshold in the thermal asperity detector operably connected to the MR head;
applying a read bias to the MR head;
reading a signal emanating from the MR head positioned over an erased track;
counting a number of occurrences of signals that exceed the threshold; and
determining transducer magnetic instability for the MR head based on the number of occurrences of signals that exceed the threshold.

2. The method in claim 1, further comprising:
adjusting the read bias to a new value within a range of values, the range of values based on a characteristic of the MR head; and
repeating the steps of reading, counting, and determining.

3. The method in claim 2, further comprising:
re-setting the thermal asperity detector to a new threshold; and
repeating the steps of reading, counting, and determining.

4. The method in claim 3 further comprising:
realigning magnetic domains within the MR head if the number of signal occurrences exceeds a pre-determined number.

5. A computer readable medium having computer-executable instructions for performing the steps recited in claim 4.

6. A method for detecting transducer magnetic instability in a magneto-resistive (MR) head in an operating disc drive, the method comprising steps of:
setting a signal threshold in a thermal asperity detector in a disc drive read channel circuit;
setting a read bias in the read channel circuit;
reading an erased track on a disc in the drive to detect a signal emanating from the MR head; and
counting an occurrence of the signal if the signal exceeds the signal threshold.

7. The method in claim 6, further comprising:
re-setting the read bias to a new bias; and
repeating the reading and counting steps.

8. The method in claim 7, further comprising:
performing the re-setting and repeating steps for a pre-determined number of repetitions.

9. The method in claim 7, further comprising:
performing the re-setting and repeating steps until there are no occurrences of signals that exceed the threshold.

10. The method in claim 8, wherein the pre-determined number of repetitions is five (5).

11. The method in claim 8, further comprising:
re-setting the signal threshold to a new signal threshold; and
repeating the setting of a read bias, the reading on a erased track, and the counting of signal occurrences.

12. The method in claim 11, further comprising:
repeating the re-setting of the signal threshold for a pre-determined number of repetitions.

13. The method in claim 12, further comprising:
setting a first criterion based on a characteristic of the MR head;
comparing the counted number of occurrences of the signals that exceed the threshold to the first criterion to determine a reliability value to the MR head.

14. The method in claim 13, further comprising:
rejecting the MR head if the reliability value is outside a second criterion.

15. The method in claim 13, further comprising:
re-aligning magnetic domains within the MR head based on the reliability value.

16. The method in claim 6, further comprising:
attenuating the signal emanating from the MR head to a level within a range of pre-determined signal thresholds.

17. The method in claim 6, further comprising:
amplifying the signal emanating from the MR head to a level within a range of pre-determined signal thresholds.

18. A computer readable medium having computer-executable instructions for performing the steps recited in claim 8.

19. A computer readable medium having computer-executable instructions for performing the steps recited in claim 11.

20. A computer readable medium having computer-executable instructions for performing the steps recited in claim 13.

21. An apparatus for detecting and measuring instability in a magneto-resistive (MR) head in an operating disc drive, the MR head having a magnetic orientation and positioned over a pre-determined track on a disc in the drive, the apparatus comprising:
a thermal asperity detector circuit in a read channel of the disc drive operably connected to the MR head, the thermal asperity detector having an adjustable threshold set to a pre-determined value; and
a means for utilizing the thermal asperity detector circuit to determine magnetic instability.

22. The apparatus in claim 21, further comprising:
a read bias applied to the MR head, the bias selected from a range of values, the values based on the MR head resistance to a magnetic field; and
a signal generated by the MR head, the MR head positioned over an erased track.

23. The apparatus of claim 22 wherein the apparatus further comprises:
a means for adjusting the bias to re-orient the magnetic domains within the MR head based on the number of occurrences of signals exceeding the pre-determined threshold value.

24. The apparatus in claim 21, further comprising:
a software module operably connected to the thermal asperity detector comparing a signal from the MR head to the pre-determined threshold, the MR head positioned over an erased track, the software module counting occurrences in which the signal exceeds the pre-determined threshold value.

25. The apparatus in claim 21, further comprising:
a means for generating a signal by the MR head, the MR head positioned over an erased track; and
a means for comparing the signal to the pre-determined threshold, counting occurrences in which the signal exceeds the pre-determined threshold value.

26. The apparatus of claim 23 wherein the software module further comprises:
a comparator operably connected to the read channel comparing the signal from the MR head to the pre-determined threshold value; and
a counting unit operably connected to the comparator counting occurrences in which the signal exceeds the pre-determined threshold value.

27. The apparatus of claim 23 wherein the thermal asperity detector is operably connected to the MR head via a pre-amplifier and the software module is operably connected to the thermal asperity detector via the pre-amplifier.

28. The apparatus of claim 21 wherein the apparatus further comprises:
a means for adjusting the signal emanating from the magneto-resistive head, the adjustment attenuating/amplifying the signal to a level within the range of settings for the threshold.
